(19) United States
(12) Patent Application Publication
(10) Pub. No.: US 2009/0158024 A1
(43) Pub. Date: Jun. 18, 2009

(54) DUAL BIOS CIRCUIT

(75) Inventors: JUI-TING HUNG, Tu-Cheng (TW); CHIH-MING KUO, Tu-Cheng (TW); MING-YI SHIH, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/963,860

(22) Filed: Dec. 24, 2007

(30) Foreign Application Priority Data
Dec. 12, 2007 (CN) 200710203022.8

(51) Int. Cl. G06F 15/177

(52) U.S. Cl. 713/2

(57) ABSTRACT

A dual BIOS circuit includes a first BIOS chip, a second BIOS chip, and a transistor. The first and the second BIOS chip include a setup program configured for setting the voltage of a GPIO pin of a Southbridge chip. The first and the second BIOS chip are connected to the Southbridge chip. The gate of the transistor is connected to the GPIO pin of the Southbridge chip. The drain of the transistor is connected to a power supply via a resistor, and connected to a detecting pin of the Southbridge chip. The source of the transistor is grounded. The power supply is connected to a signal pin of the Southbridge chip. The first or second BIOS chip is selected to operate according to the voltage level at the detecting pin of the Southbridge chip.

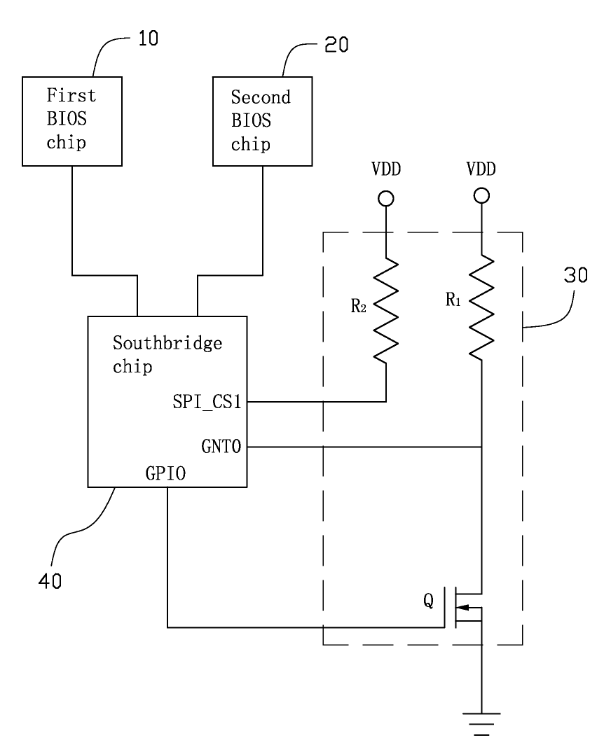

### CROSS-REFERENCE TO RELATED APPLICATIONS

Relevant subject matter is disclosed in a co-pending U.S. patent application (Attorney Docket No. US18062) filed on the same date and having a same title, which is assigned to the same assignee as this patent application.

### BACKGROUND OF THE INVENTION

1. Field of the Invention

The present invention relates to a dual bios circuit.

2. Description of Related Art

A motherboard can be destroyed through improper flashing of the BIOS (Basic Input Output System) or through manual modifications of the flash file. In such a situation, either the BIOS cannot be loaded without errors, or invalid settings are assigned to the components. For this reason, some manufacturers, such as Gigabyte, offer a dual BIOS function to many of their motherboards.

A motherboard includes two BIOS chips: a main BIOS and a backup BIOS. This type of motherboard setup helps a motherboard recover from any issue that may happen during a BIOS update, protects the BIOS from any potential virus, and helps with any other issues that may arise related to the BIOS. However, the backup BIOS is only a back-up for the main BIOS, it has no additional functions.

What is needed, therefore, is a dual BIOS circuit which can solve the above problem.

### SUMMARY

An exemplary dual BIOS circuit includes a first BIOS chip, a second BIOS chip, and a transistor. The first and the second BIOS chip include a setup program configured for setting the voltage of a GPIO pin of a Southbridge chip of a motherboard. The first and the second BIOS chip are connected to the Southbridge chip. The gate of the transistor is connected to the GPIO pin of the Southbridge chip. The drain of the transistor is connected to a power supply via a resistor, and a detecting pin of the Southbridge chip. The source of the transistor is grounded. The power supply is connected to a signal pin of the Southbridge chip. The first or second BIOS chip is selected to operate according to the voltage level at the detecting pin of the Southbridge chip.

Other advantages and novel features will become more apparent from the following detailed description when taken in conjunction with the accompanying drawing, in which:

### BRIEF DESCRIPTION OF THE DRAWINGS

The drawing is a circuit diagram of one embodiment of a dual BIOS circuit in accordance with the present invention.

### DETAILED DESCRIPTION

Referring to the drawing, a dual BIOS circuit in accordance with an embodiment of the present invention includes a first BIOS chip 10, a second BIOS chip 20, and a control circuit 30. In this embodiment, the first BIOS chip is an FWH (Firmware Hub) BIOS chip, and it loads AWARD code. The second BIOS chip is an SPI□Serial Peripheral Interface□BIOS chip, and it loads AMI code. The AWARD code and the AMI code are two different programs, which are firmware used for communication between hardware and an operating system of an electronic device. The first and second BIOS chips each load a setup program. The setup program is configured to set the voltage of GPIO pins of a motherboard.

The first and second BIOS chips each are connected to a Southbridge chip 40 of the motherboard. The Southbridge chip 40 includes an SPI_CS1 signal pin, a GNT0 detecting pin, and a GPIO pin. According to the INTEL standard, Table 1 shows voltage levels of the GNT0 detecting pin and the SPI_CS1 signal pin when the first or second BIOS chip is selected to operate.

TABLE 1

| | Voltage level | Voltage level of |
|---|---|---|
| | of GNT0 | SPI_CS1 |
| The first BIOS | 0 | 1 |
| chip | | |
| The second | 1 | 1 |
| BIOS chip | | |

The control circuit 30 includes a transistor Q, a first resistor R1, and a second resistor R2. The first transistor Q is an NMOS transistor. The gate of the first transistor Q is connected to the GPIO pin of the Southbridge chip 40. The drain of the first transistor Q is connected to a power supply VDD via a first resistor R1. The source of the first transistor Q is grounded. The SPI_CS1 signal pin of the Southbridge chip 40 is connected to the power supply VDD via the second resistor R2. The GNT0 detecting pin of the Southbridge chip 40 is connected to the drain of the first transistor Q.

When the motherboard is powering up, the GPIO pin of the Southbridge chip 40 is at a TTL low level. The transistor Q turns off. The GNT0 detecting pin is at a TTL high level. The SPI_CS1 signal pin is at a TTL high level. Thus the first BIOS chip 10 starts.

Alternatively, the GPIO pin of the Southbridge chip 40 can be changed to be at a TTL high level via the setup program of the first BIOS chip 10. Then the transistor Q turns on. The GNT0 detecting pin is at a TTL low level. The SPI_CS1 signal pin is at a TTL high level. Thus the second BIOS chip 20 starts, and the first BIOS chip 10 shuts down.

Thus, the dual BIOS circuit can make one of the first and the second BIOS chip 10, 20 start to suit the needs of users.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternately embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A dual BIOS circuit comprising:
a first BIOS chip;
a second BIOS chip, the first and second BIOS chips each comprising a setup program configured for setting the voltage of a GPIO pin of a Southbridge chip, the first and second BIOS chips connected to the Southbridge chip;
a transistor, the gate of the transistor connected to the GPIO pin of the Southbridge chip, the drain of the transistor connected to a detecting pin of the Southbridge chip, the source of the transistor being grounded; and
a power supply connected to the drain of the transistor via a resistor, and connected to a signal pin of the Southbridge chip.

2. The dual BIOS circuit as claimed in claim 1, wherein the first BIOS chip is a Firmware Hub (FWH) BIOS chip, and it loads AWARD code; the second BIOS chip is a Serial Peripheral Interface (SPI) BIOS chip, and it loads AMI code.

3. The dual BIOS circuit as claimed in claim 1, wherein the transistor is an NMOS transistor.

4. The dual BIOS circuit as claimed in claim 1, wherein the signal pin of the Southbridge chip is an SPI_CS1 signal pin.

5. The dual BIOS circuit as claimed in claim 1, wherein the detecting pin of the Southbridge chip is a GNT0 pin.

6. The dual BIOS circuit as claimed in claim 1, wherein the power supply is connected to the signal pin of the Southbridge chip via a resistor.
